(19) United States
(12) Patent Application Publication
(10) Pub. No.: US 2026/0255103 A1
(43) Pub. Date: Aug. 27, 2026

(54) RAPID CALIBRATION OF MULTIPLE LOUDSPEAKER ARRAYS

(71) Applicant: SRI International, Menlo Park, CA (US)

(72) Inventor: Aaron Joel Heller, Belmont, CA (US)

(21) Appl. No.: 18/761,140

(22) PCT Filed: Mar. 13, 2023
(86) PCT No.: PCT/US2023/015094

§ 371 Date: Jul. 1, 2024

Related U.S. Application Data
(60) Provisional application No. 63/321,510, filed on Mar. 18, 2022.

(51) Int. Cl. H04R 3/04; H04R 29/00

(52) U.S. Cl. CPC H04R 3/04; H04R 29/002

(57) ABSTRACT

A waveform generator can generate two or more sequences of uniquely coded waveforms. The waveform generator can then output at least one of i) each uniquely coded waveform itself, ii) parameters for each uniquely coded waveform, and iii) a combination of both. The uniquely coded waveforms each have a known sequence of at least one of 1) different lengths, 2) different amplitude values, and a 3) combination of both forming a unique identifier for that known sequence as inputs into multiple loudspeakers in an array being tested. The multiple loudspeakers generate the audio signals. Each audio signal has its own uniquely coded waveform with the known sequence. The multiple loudspeakers generate the audio signals at approximately a same time to be received by one or more microphones to perform a simultaneous characterization of at least one of i) a calibration of, and ii) a performance of the multiple loudspeakers in the array.

### RELATED APPLICATIONS

This application claims priority to and the benefit of under 35 USC 119 of U.S. provisional patent application titled “Rapid calibration of multi-loudspeaker arrays,” filed Mar. 18, 2022, Ser. No. 63/321510.

### FIELD

Embodiments generally relate to a calibration of multi-loudspeakers and/or audio receivers.

### BACKGROUND

An example of a survey of measurement and calibration of sound reproduction systems is in F. Toole, “The Measurement and Calibration of Sound Reproducing Systems,” J. Audio Eng. Soc., vol. 63, no. 7, pp. 512-541, August 2015.[1]. An example of a survey of acoustic impulse response measurement techniques is in G.-B. STAN, J.-J. EMBRECHTS, AND D. ARCHAMBEAU, “COMPARISON OF DIFFERENT IMPULSE Response Measurement Techniques,” J. Audio Eng. Soc., vol. 50, no. 4, pp. 249-262, Apr. 2002. A major limitation is that each impulse response must be measured separately. So the time required for testing is proportional to the number of loudspeakers (e.g. increased by the number of loudspeakers). Each measurement takes several seconds, so for large arrays, the entire set of measurements can take over 10 minutes. Furthermore, it is desirable to repeat the measurements a few times. Some of the techniques involve playing out pure tones/chirps at relatively high levels, which are annoying to hear.

### SUMMARY

Provided herein are some embodiments of testing of multiple loudspeakers and/or audio receivers. An embodiment can be directed to a simultaneous calibration of multiple loudspeaker arrays and/or audio receivers. A waveform generator can generate two or more sequences of uniquely coded waveforms. The waveform generator can then output at least one of i) each uniquely coded waveform itself, ii) parameters for each uniquely coded waveform, and iii) a combination of both. The uniquely coded waveforms each have a known sequence of at least one of 1) different lengths, 2) different amplitude values, and a 3) combination of both forming a unique identifier for that known sequence as inputs into multiple loudspeakers in an array being tested. The multiple loudspeakers generate the audio signals. Each audio signal has its own uniquely coded waveform with the known sequence. The multiple loudspeakers generate the audio signals at approximately a same time to be received by one or more microphones to perform a simultaneous characterization of at least one of i) a calibration of, and ii) a performance, e.g. detection of degraded performance, of the multiple loudspeakers in the array.

These and other features of the design provided herein can be better understood with reference to the drawings, description, and claims, all of which form the disclosure of this patent application.

### BRIEF DESCRIPTION OF THE DRAWINGS

The drawing refers to example embodiments of the design.

FIG. 1 illustrates a block diagram of an embodiment of a waveform generator supplying a uniquely coded waveform itself and/or ii) the parameters for each uniquely coded waveform to corresponding multiple loudspeakers in an array being tested at approximately a same time.

FIG. 2 illustrates a block diagram of an embodiment of an audio receiver with convolution filters in the audio receiver to match up the audio signals generated by individual loudspeakers in the multiple loudspeaker array to the uniquely coded noise waveform within the audio signal sent to that particular loudspeaker.

FIG. 3 illustrates a graph diagram of example low-cross-correlation, pseudorandom, binary sequence of known sequence of different lengths and amplitude values, in essence, each forming its own unique signature generated by the binary sequence generator.

FIG. 4 illustrates a graph diagram of two example impulsive responses coming from, in this example, loudspeaker number five and loudspeaker number six that are created by the audio processing in the audio receiver.

FIG. 5 illustrates a graph diagram of example impulsive responses coming from, in this example, loudspeaker number five and loudspeaker number six as well as their corresponding frequency responses created by the audio processing.

FIG. 6 shows more examples of the audio receiver producing and analyzing impulse responses generated by the corresponding known sequences of different lengths and amplitude values the impulse and the corresponding impulse response and then the frequency response that corresponds to that impulse response.

FIG. 7 illustrates a diagram of an embodiment of a computing device that can be a part of the systems associated with the waveform generator, the audio receiver, and other associated modules discussed herein.

While the design is subject to various modifications and alternative forms, specific embodiments thereof have been shown by way of example in the drawings and will herein be described in detail. The design should be understood to not be limited to the particular forms disclosed, but on the contrary, the intention is to cover all modifications, equivalents, and alternatives falling within the spirit and scope of the design.

### DETAILED DISCUSSION

In the following description, numerous specific details are set forth, such as examples of specific data signals, named components, etc., in order to provide a thorough understanding of the present design. It will be apparent, however, to one of ordinary skill in the art that the present design can be practiced without these specific details. In other instances, well-known components or methods have not been described in detail but rather in a block diagram in order to avoid unnecessarily obscuring the present design. Further, specific numeric references, such as a first loudspeaker, can be made. However, the specific numeric reference should not be interpreted as a literal sequential order but rather interpreted that the first loudspeaker is different than a second loudspeaker. Thus, the specific details set forth are merely exemplary. Also, the features implemented in one embodiment may be implemented in another embodiment where logically possible. The specific details can be varied from and still be contemplated to be within the spirit and scope of the present design. The term coupled is defined as meaning connected either directly to the component or indirectly to the component through another component.

The rapid calibration of multi-loudspeaker arrays has many features, and some example features will be discussed below. In general, an embodiment discussing a rapid calibration of multi-loudspeaker arrays will be discussed as an example embodiment.

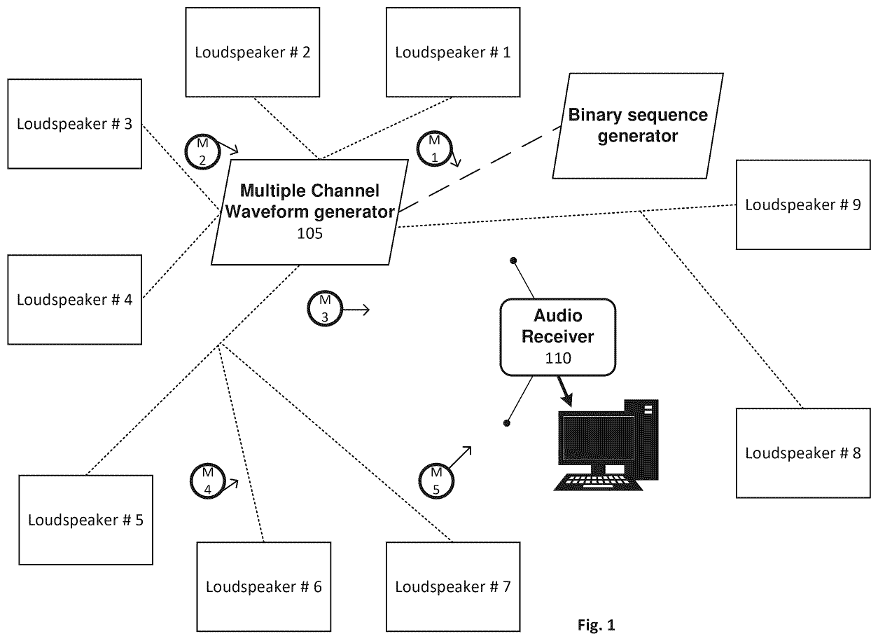

FIG. 1 illustrates a block diagram of an embodiment of a waveform generator supplying a uniquely coded waveform itself and/or ii) the parameters for each uniquely coded waveform to corresponding multiple loudspeakers in an array being tested at approximately a same time. In this example, the multiple channel waveform generator 105 generates nine different sequences of uniquely coded waveforms with known sequences of different lengths and amplitude values. The nine different sequences of uniquely coded waveforms are supplied to loudspeaker number 1 through loudspeaker number 9. Each of the nine loudspeakers is going to generate its own audio signals based upon receiving those uniquely coded waveforms. The nine loudspeakers are three dimensionally arranged in an area, such as a theater, an auditorium, home theater system, and even an automobile, so that people hearing the loudspeakers are designed to hear all nine loudspeakers at different times or all at the same time depending upon what audio is being intended to be heard. In addition, in this example area, there are five different microphones M1 through M5 each positioned geographically in this area to receive the audio signals coming from loudspeaker number 1 through loudspeaker number 9. In this example, microphones M1 through M5 supply the received audio signals from the nine different loudspeakers to an audio receiver 110 for processing, all at approximately a same time. A binary sequence generator can supply the known sequences of different lengths and amplitudes such that nine different uniquely coded waveforms are generated with those nine different known sequences of different lengths and amplitude values. The binary sequence generator supplies the same set of known sequences of different lengths and amplitude values to a corresponding loudspeaker from loudspeakers number 1 through number 9 to the audio receiver 110. The audio receiver 110 can then match up a particular known sequence of different lengths and amplitude values and its corresponding loudspeaker even though, in this example, nine different audio signals are being received by five different microphones and all are being processed at approximately at a same time by the audio receiver 110.

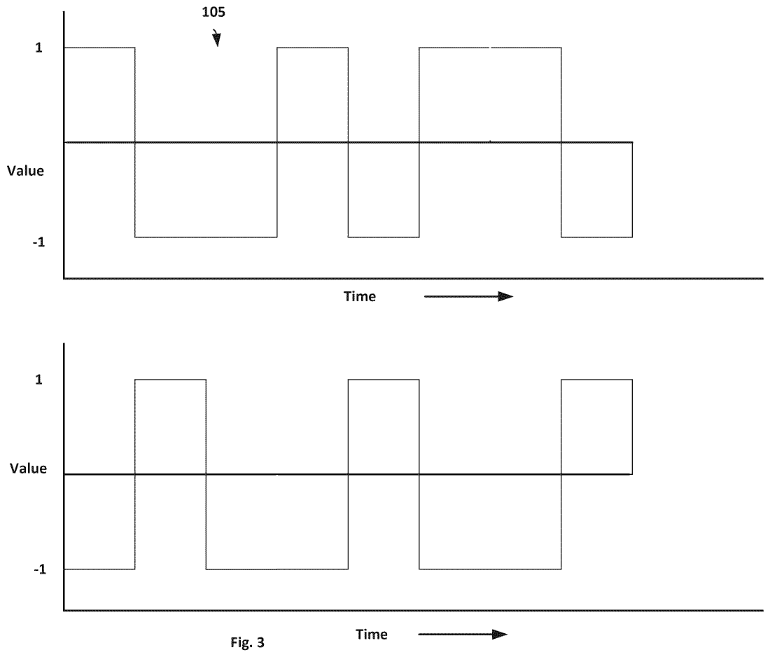

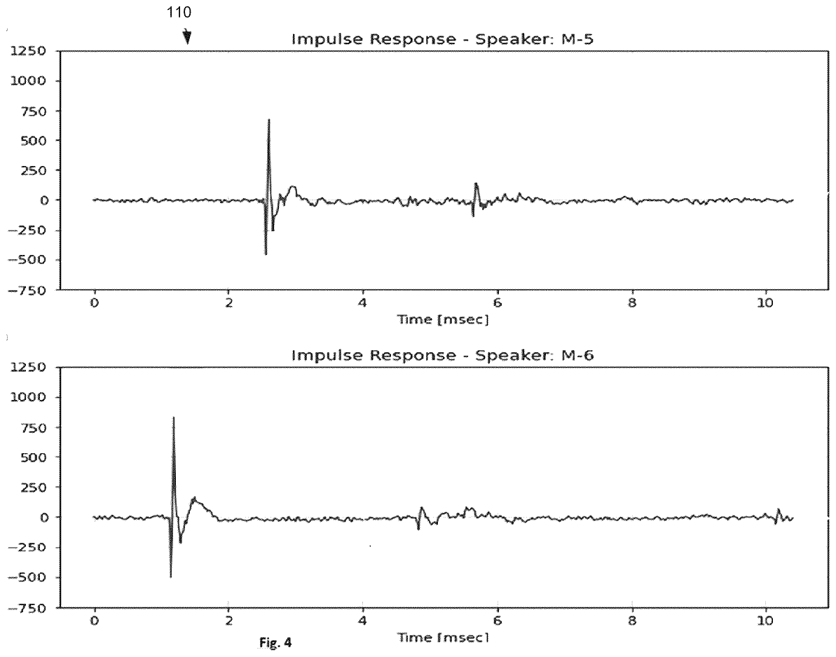

Thus, the waveform generator 105 can contain a binary or analog sequence generator that generates two or more sequences of uniquely coded waveforms. The waveform generator 105 generates as its output at least one of i) each uniquely coded waveform itself, ii) the parameters for each uniquely coded waveform, and iii) a combination of both. The uniquely coded waveforms each have a known sequence of at least one of 1) different lengths, 2) different amplitude values, and a 3) combination of both, such as sequences of logical 1s and logical 0s, for inputs into an array of multiple loudspeakers being tested. In an embodiment, the known sequence is a combination of both different lengths and different amplitude values forming a unique identifier for that known sequence as an input into a corresponding loudspeaker. (See, for example FIGS. 3 and 4) The audio signals out of the multiple loudspeakers each contain their own uniquely coded waveforms with the known sequence of different lengths and amplitudes. The multiple loudspeakers are configured to generate the audio signals at approximately a same time. One or more microphones are configured to receive the soundwaves to perform a simultaneous characterization of at least one of i) a calibration of, and ii) a performance, e.g., detection of degraded performance, of the multiple loudspeakers in the multiple loudspeaker array. Thus, each loudspeaker in the multiple loudspeaker array is being tested essentially simultaneously. Note, ‘at approximately the same time’ means equal to or under 2,600 milli-seconds. In general, the speed of sound travels at 1100 feet/second; and thus, approximately one foot per millisecond. A mile is approximately 5,200 feet. Thus, the furthest distance and time between generation of the unique waveform to the particular loudspeaker in that loudspeaker array generating its corresponding audio signal and a microphone receiving that audio signal is approximately 2,600 milli-seconds or less; and thus, all of the speakers and microphones would be positioned within roughly within a half of a mile or less from each other. The multiple channel digital to analog generator can generate, for example, any number, such as nine, different uniquely coded noise waveforms each sent to its own corresponding loudspeaker. Each loudspeaker, for example, in an outdoor arena or even an auditorium can be several hundred feet away from a microphone picking up the broadcast audio signals from the loudspeakers.

The waveform generator 105 can be a multiple channel digital to analog generator that is configured to supply the sequence of uniquely coded noise waveforms, which include at least the known sequence of different lengths and amplitude values that are offset enough in pattern from each other to be separated in into its own audio channel. The multiple channel digital to analog generator sends this to each loudspeaker being tested so that each particular loudspeaker is configured to receive its own audio channel signal in an audio frequency range from the multiple channel digital to analog generator. The binary sequence generator may be a part of the waveform generator 105 or merely communicatively coupled to the waveform generator 105.

Note, the uniquely coded waveforms supplied from the waveform generator 105 have parameters such that when the multiple loudspeakers generate the audio signals, then the audio signal generated by the loudspeaker sounds like a hissing noise. The uniquely coded noise waveforms, such as a white noise/hiss sound, will generally be at or below a decibel level of 50 dB or less to allow testing of the loudspeakers while human audience members will not be annoyed by the testing. In an example, the noise/hiss sound will generally be generated by the speakers at or below a whisper decibel level of 30 dB or less. The white noise will have roughly the same energy at all frequencies, except DC.

In an embodiment, a single microphone is positioned at a geographically known location relative to each of the multiple loudspeakers being tested at the same time rather than five microphones M1-M5 as shown in FIG. 1. Either way, the one or more microphones act as inputs into an audio receiver 110. The one or more microphones M1-M5 are positioned at geographically known locations relative to each of the multiple loudspeakers positioned to receive the audio signal from each loudspeaker in the multiple loudspeaker array being tested at the same time. The audio receiver 110 can factor in the known distances; and thus, time between a particular loudspeaker and a particular microphone receiving that loudspeaker's audio signals when doing the calibrations and performance tests. For example, microphone M1 has a different known distance between itself and, for example, loudspeakers #2, #3, and #4. In addition, microphone M1's known distances that will be factored into the calibration and performance calculations is different than microphone M5 that also has a different known distance between itself and, for example, loudspeakers #2, #3, and #4.

Each microphone M1-M5 is configured to feed received audio signals, e.g. sound waves, transmitted/generated from each of the multiple loudspeakers into one or more audio receivers 110 as well as insert/attach a unique identifier associated with that microphone into the received audio signals (e.g. sound waves) so that the audio receiver 110 can process all of the audio signals transmitted/generated by the group of the multiple loudspeakers at a same time as well as factor in a geographically known location of each microphone relative to geographically known locations of each of the multiple loudspeakers. In this example, the audio receiver 110 is processing received audio signals from nine different microphones and each received audio signal communicated to the audio receiver 110 has that microphone's unique identifier attached and/or inserted into the communicated audio signal.

In an embodiment, the rapid calibration of multi-loudspeaker arrays allows the simultaneous calibration of all loudspeakers in an array versus the current practice of performing the calibration separately, and in series with each other, for each loudspeaker. Hence, the rapid calibration of a multi-loudspeaker array speeds up the calibration proportional to the number of speakers in the array. Again, the system can use uniquely coded noise waveforms to perform the simultaneous characterization of each speaker in a multiple loudspeaker array so that the generated audio signals both can be identified from each other and not have cross talk with each other to interfere with the measurements of these audio signals during the testing. Thus, the calibration of multiple loudspeaker arrays simultaneously (approximately at the same time) can use a set of low-cross-correlation, pseudorandom, binary sequences acting as unique identifiers to test all of the speakers.

In an embodiment, the first step in calibrating the array of loudspeakers is the binary sequence generator software in the waveform generator 105 is coded to create sets of low-cross-correlation, pseudorandom, binary sequences for inputs into the speakers in the array being tested. The rapid calibration of multi-loudspeaker arrays can be implemented with Python NumPy and SciPy libraries for signal processing. Note, calibration can include measuring the frequency, the phase, level, and the temporal behavior of a loudspeaker as installed in an array.

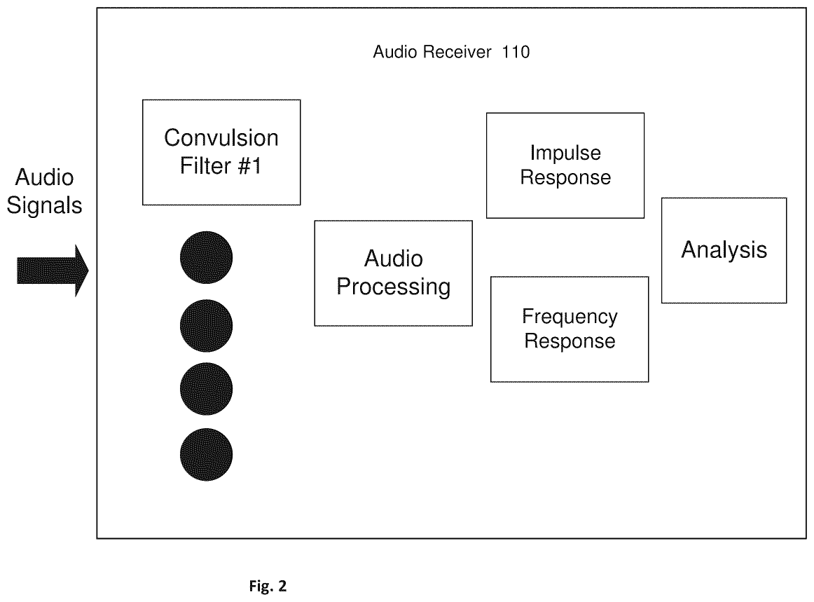

FIG. 2 illustrates a block diagram of an embodiment of an audio receiver with convolution filters in the audio receiver to match up the audio signals generated by individual loudspeakers in the multiple loudspeaker array to the uniquely coded noise waveform within the audio signal sent to that particular loudspeaker.

The audio receiver 110 contains an audio digital signal processor (dsp) that has filters and audio processing circuits to electronically tease received audio signals in the audio signals apart and produce individual impulse responses corresponding to each particular loudspeaker in the multiple loudspeaker array being tested at the same time.

Again, a binary sequence generator can communicate with both the waveform generator 105 and the audio receiver 110 to supply the sequences of uniquely coded noise waveforms which include at least the known sequence of different lengths and amplitude values for inputs into each particular loudspeaker over to the audio receiver 110 so that the convolution filters in the audio receiver 110 can match up a particular audio signal with the uniquely coded noise waveform generated by an individual loudspeaker in the array to the known sequence of different lengths and amplitude values sent to that particular loudspeaker. (See FIGS. 3 and 4, for example, pseudorandom sequences that, in essence, each form its own unique known sequence of different lengths and amplitudes.

Again, the filters and audio processing circuits cooperate to electronically tease received audio signals in the audio signals apart and produce individual impulse responses corresponding loudspeaker in the multiple loudspeaker array being tested at the same time. The audio receiver 110 can have a set of convolution filters equal to or greater than an amount of multiple loudspeakers being tested at the same time in the audio receiver 110 so that the set of convolution filters can correlate the audio signal generated by an individual loudspeaker in the array over to the uniquely coded waveform sent to that particular loudspeaker. Thus, each loudspeaker was sent its own uniquely coded noise waveform. The audio processing in the audio receiver 110 processes each received audio signal that each contains its own uniquely coded noise waveform that has the known sequence of different lengths and amplitude values correlatable to a corresponding loudspeaker in the array. Each of the uniquely coded noise waveforms, which each have at least have a known sequence of different lengths and amplitude values waveforms such that low-cross-correlation occurs, used for inputs into the loudspeakers, are offset enough in pattern from each other to be separated in into its own audio channel for audio processing. The audio processing, based on knowing the known sequence of different lengths and amplitude values correlatable to a corresponding loudspeaker, can factor in during the calibration and the audio performance tests that each of the multiple microphones each has its own known geographic location in relation to a geographic location of each speaker in the array being tested. Each of the microphones can supply their received audio signals from the multiple loudspeakers broadcasting their audio signals while being tested a same time to a single audio receiver 110 or multiple audio receivers for audio processing. Note, the rapid calibration of multiple loudspeaker arrays does not have to track what ambient noise is being generated when each individual loudspeaker is being tested because all of the loudspeakers are being tested at approximately the same time; and thus, the ambient noise at the microphone (e.g. any type of audio receiver 110) is about the same at the time when the generated audio signal from the speaker is being received at the microphone.

FIG. 3 illustrates graph diagrams of example low-cross-correlation, pseudorandom, known sequences of different lengths and amplitude values, in essence, each forming its own unique signature generated by the binary sequence generator. This set of low-cross-correlation, pseudorandom, binary sequences is fed into the waveform generator 105, such as a multiple-channel digital-to-analog generator, and/or generated internally by the binary sequence generator software within the waveform generator 105. Each different binary sequence generated corresponds to its own audio channel and is inputted into the multiple-channel waveform generator 105. Each loudspeaker can be tested at approximately the same time receive its own audio channel signal in the audio frequency range from the multiple-channel waveform generator 105. The top graph of known sequences of different lengths and amplitude values has a series of logical ones and zeros. In this example, the known sequence (10010110) in the top graph starts off with a logical one with a value of positive one (1), followed by a series of logical zeros with a value of minus one (−1), followed by another logical one, followed by another logical zero with a value of −1, followed by two logical ones at a value of 1, and finally followed by a logical zero at a value of −1. The bottom graph of known sequences (01001001) starts off with a logical zero with a value of −1, followed by a logical one with a value of 1, followed by two logical zeros each having a value of −1, followed by a logical one with a value of 1, followed by two logical zeros each with a value of −1, and finally followed by a logical one with a value of 1.

Thus, the rapid calibration of multi-loudspeaker arrays can use sets of low- cross-correlation, pseudorandom, binary sequences for calibration, such as Gold or Kasami Sequences. The multiple unique binary sequences are separated enough such that low cross-correlation occurs between any of the supplied audio channel inputs into the array of loudspeakers. (See, FIG. 4 for an example of impulse responses corresponding to the known sequence of different lengths and amplitude values.) In essence, each speaker being tested will have as an input its own unique known sequence of different lengths and amplitude values and turn that into an audio signal in the audio acoustic frequency range. By assigning an offset enough to have low cross-correlation between inputted binary sequences to each loudspeaker, the system at a microphone can record the outputs of all of the speakers being tested simultaneously. The microphone at that location can record the different binary known sequence of different lengths and amplitude values from each speaker in the array (each speaker being fed their own unique known sequence of different lengths and amplitude values). Thus, this step in calibrating the array of loudspeakers is to measure the impulse response from each loudspeaker to one or more listening positions (e.g., microphone locations) receiving an audio signal from each speaker being tested at the same time.

FIG. 4 illustrates a graph diagram of two example impulsive responses coming from, in this example, loudspeaker number five and loudspeaker number six that are created by the audio processing in the audio receiver 110. Again, the audio receiver 110 contains the audio digital signal processor that has filters and audio processing circuits to electronically tease the received audio signals apart and produce individual impulse responses corresponding to each loudspeaker in the multiple loudspeaker array being tested at the same time. The audio processing can generate an impulse response of that audio channel. The different members of the family of known sequences of different lengths and amplitude values can have a single distinguishable peak and low crosstalk. The series of match convolutional filters pick out the waveform from each speaker due to the properties of these waveforms. The impulse responses are plotted based on the signal level and overtime. The vertical spikes of impulse response waveforms are time separated by a few milliseconds. The known sequence of different lengths and amplitude values can be seen to be different between the top impulse response from speaker 5 and the bottom impulse response from speaker 6. Also, they differ in that after the initial spike of the top impulse response, the top impulse response has a little positive peak followed by another positive peak and then eventually goes down. Whereas, the bottom impulse response after the initial spike has a gradual increase to a positive peak and then gradual downward slope. These different impulses responses are corresponding to the known sequence of different lengths that amplitude values that are being supplied through the uniquely coded wave forms to the loudspeakers for them to generate sound waves/audio signals with. Microphones supply the received sound waves to an audio receiver 110 which is going to perform audio processing to create impulse responses and corresponding frequency responses which can be decoded to match up the peaks and spikes to the known sequence.

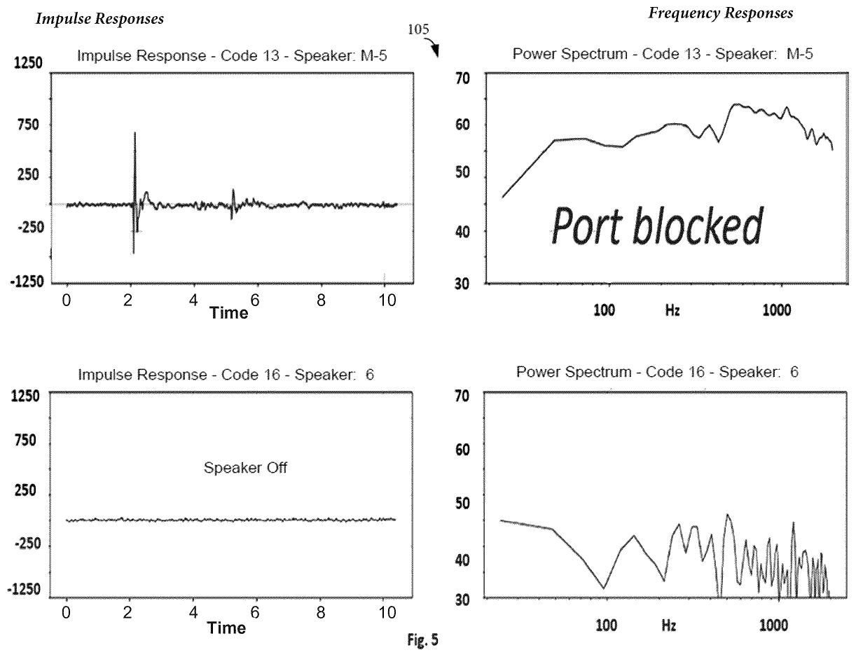

FIG. 5 illustrates a graph diagram of example impulsive responses coming from, in this example, loudspeaker number 5 and loudspeaker number 6 as well as their corresponding frequency responses created by the audio processing. The top figure in FIG. 5 shows the impulse response from speaker number 5 and then the corresponding frequency response created by the audio receiver 110 in which an expert and/or software analysis tool can tell that a port is blocked on that speaker which can be determined during the calibration and testing. The audio receiver 110 creates and analyzes both the impulse response and, on the right hand side, the frequency response derived from that impulse response. The bottom graph shows the impulse response of speaker number 6 and corresponding frequency response, which the audio processing circuit creates and the audio software analysis tool can determine that the speaker is off and roughly flatlined throughout the entire test.

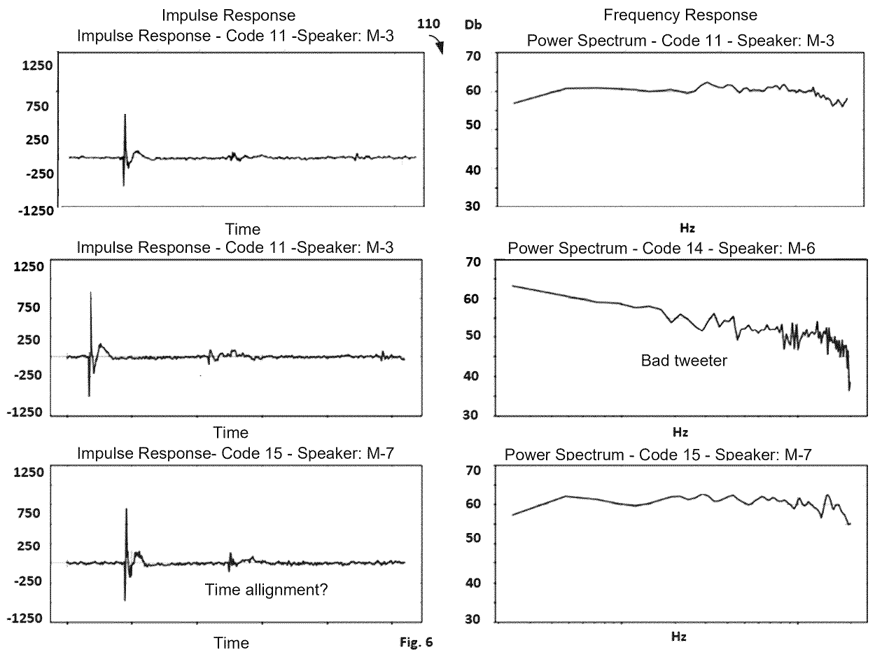

FIG. 6 illustrates a graph diagram of example of more examples of the audio receiver producing and analyzing impulse responses generated by the corresponding known sequences of different lengths and amplitude values the impulse and the corresponding frequency response that corresponds to that impulse response. The top graph is an example impulse response and frequency response from speaker number 3 that would pass the performance and calibration testing. In the middle graph, an expert and/or the audio software analysis tool could tell that the speaker number 6, identified by the known sequence, that the broadcasted audio signals from the loudspeaker indicate that it has a bad tweeter from the frequency response produced by the audio receiver 110. The bottom graph shows the example impulse response of loudspeaker number 7, which is determined by again the filters in the audio receiver 110 matching up to the known sequence. The audio receiver 110 from knowing a timing of the family of known sequences sent to each corresponding loudspeaker that the time alignment on speaker number 7, which comes after loudspeakers number 3 and 6 that there is a time alignment issue between receiving the sounds in the audio signals from those speakers and the sending of the unique waveform to its corresponding loudspeaker. The impulse responses corresponding to the known sequences are sequentially slightly different in time, (e.g., one impulse response has a little bit more advanced of time than another, which is delayed in time and then the next impulse response is again almost at the same time again.)

Again, the rapid calibration of multi-loudspeaker arrays can use sets of low- cross-correlation, pseudorandom, binary sequences for calibration, such as Gold or Kasami Sequences. The multiple unique binary sequences separated enough such that low cross-correlation occurs between any of the supplied audio channel inputs into the array of loudspeakers. The impulse responses in, for example, FIG. 4 can be corresponded to the known sequences of different lengths and amplitude values in FIG. 3. In essence, each speaker being tested will have as an input its own unique known sequence of different lengths and amplitude values and turn that into an audio signal in the audio acoustic frequency range. By assigning an offset enough to have low cross-correlation between inputted binary sequences to each loudspeaker, the system at a microphone can record the outputs of all of the speakers being tested simultaneously. The microphone at that location can record the different binary known sequence of different lengths and amplitude values from each speaker in the array (each speaker being fed their own unique known sequence of different lengths and amplitude values). Thus, this step in calibrating the array of loudspeakers is to measure the impulse response from each loudspeaker to one or more listening positions (e.g., microphone locations) receiving an audio signal from each speaker being tested at the same time.

### Pseudorandom Binary Sequences

Again, the binary sequence generator software in the waveform generator 105 is coded to create the lengths and values used in the sets of low-cross-correlation, pseudorandom, known sequence of different lengths and amplitude values used as inputs. The pseudorandom binary sequence (PRBS), pseudorandom binary code or pseudorandom bitstream can be a two-valued sequence that, while generated with a deterministic algorithm, is difficult to predict and exhibits statistical behavior similar to a truly random sequence. A common example is the maximum length sequence (M-sequence, or MLS) generated by a (maximal) linear feedback shift register (LFSR). Other examples are Gold sequences (used in CDMA and GPS), Kasami sequences, and Golay sequences, all based on LFSRs.

Zadoff-Chu sequences are a generalization, where the individual samples are complex, vs. the above where the samples are two-valued (e.g., −1 or +1).

The mathematics of these sequences is based in group theory, specifically finite integer fields. A field is a set on which addition, subtraction, multiplication, and division operations are defined and behave as the corresponding operations over rational and real numbers do. A finite field or Galois field is one with a finite number of members, such as the integers mod p, where p is prime. It contains p elements [0 . . . p−1]. Hence, the Galois field with p=2, has two elements, 0 and 1, and corresponds to Boolean algebra, where the two elements are denoted False and True. This is known as GF2.

### LFSRs

Length M shift registers with taps at certain stages that are summed modulo 2(=exclusive-or) and fed back into the first stage. If the taps are picked correctly, the shift register will cycle through every possible state of M bits except all zeros, therefore producing a sequence, S, of 2\hat{ }M−1 bits before it repeats. Such sequences are called maximal length sequences or M-sequences and we refer to M as the order of the sequence. The taps are found by factoring the polynomial 2\hat{ }(2\hat{ })−1 into the product of primitive (irreducible) polynomials mod 2. The exponents of the terms of the primitive polynomials give the locations of the taps. In general, the factorizations are not unique, so there are multiple sets of taps that each produce a different sequence. If the order of the taps is reversed, the reverse sequence is produced.

The sequence, S, produced by a LFSR is completely defined by the length of the shift register, the location of the taps or the primitive polynomial, and the initial contents of the shift register. Given a particular binary sequence, we can find the smallest LFSR that will produce it using the Berlekamp-Massey algorithm.

The k-th cyclic decimation of a sequence is produced by taking every k-th element of S. This is denoted as S[k]. If M and k are mutually prime, the sequence produced will also be maximal length. For a given set of taps, changing the initial contents of the shift register, starts the sequence at a different point, but in the same sequence. This is referred to as the phase of the sequence. The characteristic phase of a sequence is the one where the cyclic decimation by 2 results in the original sequence. M-sequences are almost balanced, they contain one more 1 than 0. People have investigated the effect of adding an additional 0, which is attractive because the sequence becomes balanced and now has a length which is a power of 2, which simplifies implementation.

### Signal Processing

In the signal processing domain, these become −1 and +1, and we substitute the adjective bipolar for binary, so, for example, we refer to pseudorandom bipolar sequences.

Welch limit of the cyclic cross correlation of two finite-length complex-valued sequences provides a lower-bound on the peak of the cross correlation. A geometric interpretation is how close to orthogonal can I make two vectors in a certain Hilbert space (a vector space in which the dot product is defined)

The Sawarte limit, same as Welch, but for bipolar valued sequences. Like the Shannon limit, these tell you what the limits are, but not how to achieve them.

In signal processing, sequences are often called “codes.”

Correlation is the same as convolution with the second sequence reversed. In signal processing, convolution is an example form of filtering. Hence the reverse of a particular sequence is its inverse filter or matched filter. In some disciplines, the inverse filtering operation is called deconvolution. Due to these properties, if the system excites a linear-time invariant (LTI) system with a M-sequence, record the system's response, and convolve it with the sequence reversed, the audio processing circuit of the audio receiver 110 obtains the impulse response of the system. The impulse response for multiple-input-multiple-output (MIMO) systems can be measured by using a different sequence (code) for each input. The contribution from each input can be separated using Digital Signal Processing and processes further, specifically convolving with original signal time reversed. How close the system is able to approach the Welch and Sawarte limits is used as a figure of merit for a given set of waveforms used for code division multiplexing.

### Properties

Bipolar M-sequences have a set of properties that make them useful impulse response measurement and spread spectrum communications. The cyclic autocorrelation of an M-sequence is two-valued, one sample's value is 2\hat{ }M−1 (the length of the sequence) and the remainder are −1, which is similar to a Dirac delta. This property is referred to as “thumbtack autocorrelation.” This leads to two other properties due to the single distinguished peak, the signals are “self-clocking;” and, the height of the single peak above the RMS value of the signal, is the “integration gain” of the sequence. The cyclic cross correlation of two different M-sequences is comprised of bounded values that are small relative to the peak of the autocorrelation. The cyclic cross correlation of an M-sequence with a Gaussian noise sequence of standard deviation 1, produces a Gaussian noise sequence of standard deviation of the root mean square of the M-sequence. The system observes that the upper bound on the cyclic cross correlation of some sequences of a give order is lower than others. These are called preferred pairs. They can be found by brute force search or with the following process utilizing cyclic decimation.

### Sets of Preferred Pairs

### Gold Sequences

In general, for a given length, there are only a few preferred pairs of M-sequences. For application where many codes are needed (GPS, CDMA cell phones), we need large number of sequences. Gold and Kasami independently came up with ways to produce large families of sequences with three-valued autocorrelations and cross-correlation statistics similar to M-sequences.
Gold's three-value theorem
Exact for m-sequences
Approximate for Gold sequences
Cross correlation properties are the same as m-sequences
Auto correlation has single distinguished peak, off peak is bounded and similar to cross correlation (different from M-sequences)
Gold sequences are not necessarily balanced. Generate a larger family and use only the balanced ones (~40%)

The vector dot product of two different (aligned) Gold sequences is −1. This means that if we are using L codes simultaneously, the peak of the matching code (which is the length of the sequence, 2\hat{ }M−1) will be reduced by L, 2\hat{ }M−L−1.

The known sequence of different lengths and amplitude values waveforms can be a set of Gold code sequences that are generated with respect to each other such that low-cross-correlation occurs between audio signals coming from different loudspeakers being tested. For example, Gold codes can have bounded small cross-correlations within a set, which is useful when multiple loudspeakers are broadcasting in the same audio frequency range. The Gold code can be a low-cross-correlation, pseudo-random, set of binary sequences that are known. A set of Gold code sequences can consist of, for example, 2ⁿ+1 sequences each one with a period of 2ⁿ−1. The binary sequence generator software in the waveform generator 105 generates a set of Gold codes with the following example steps. Pick two maximum length sequences of the same length 2ⁿ−1 such that their absolute cross-correlation is less than or equal to 2^{(n+2)/2}, where n is the size of the linear feedback shift register used to generate the maximum length sequence. The set of the 2ⁿ−1 ‘exclusive-ors’ of the two sequences in their various phases (i.e., translated into all relative positions) together with the two maximum length sequences form a set of 2ⁿ+1 Gold code sequences. Note, an ‘exclusive or’ function is a logical operation that is true if and only if its arguments differ (one is true, the other is false). Thus, A or B, but not, A and B“.” Software code or electronic circuits can be configured to carry out this logical operation.” And the exclusive-or is used to create the low-cross-correlation binary sequences. A binary sequence can include a number of ones and zeros.

As another example, the known sequence of different lengths and amplitude values waveforms can be a set of Kasami sequences that are generated with respect to each other such that low-cross-correlation occurs between audio signals coming from different loudspeakers being tested. Kasami sequences are the known sequence of different lengths and amplitude values of, for example, length 2^{N}−1 where N is an even integer. Kasami sequences have good cross-correlation values approaching the Welch lower bound. The process of generating a Kasami sequence can be initiated by generating a maximum length sequence. Maximum length sequences are periodic sequences with a period of, for example, exactly 2^{N}−1. Next, a secondary sequence is derived from the initial sequence via cyclic decimation sampling. Modified sequences are then formed by adding a(n) and cyclically time-shifted versions of the cyclic decimation sampling using modulo-two arithmetic, which is also termed the ‘exclusive or’ operation. Computing modified sequences from all 2^{N/2} unique time shifts of forms the Kasami set of code sequences.

The waveform generator 105, such as a the digital to analog multiple channel signal generator, can produce these different uniquely coded known sequence of different lengths and amplitude values. Thus, the software uses an algorithm to generate the uniquely coded waveforms that each have a known sequence of different lengths and amplitude values, such as corresponding to a logical 1 and logical 0, such that low cross-correlation occurs, for each channel output from the Digital to Analog waveform generator 105. The family of unique binary codes can be repeated seven or eight times to improve the quality of the results of the calibration tests.

### Noise Immunity

Noise immunity is important to preserve the self-clocking nature of the codes. The audio receiver 110 attempt to distinguish the single peak in an autocorrelation of how likely is the system to get a peak above a given threshold when cross correlating reduces the signal-to-noise of the derived impulse and frequency response.

### More Details on the Audio Generation and Processing

The microphone can feed the received audio signals transmitted/generated by the speakers into an audio receiver 110. Again, each loudspeaker can generate an audio signal with its corresponding known sequence of different lengths and amplitude values into the microphone and audio processing system, and the audio receiver 110 with its audio processing system can correlate the soundwaves, with the known sequence of different lengths and amplitude values, then the audio receiver 110 gets the impulse response of that speaker. The audio receiver 110 then separates the impulse responses from each speaker during the processing. Note, each separate known sequence of different lengths and amplitude values was generated such that they do not interfere with each other; and thus, the cross correlation of these is very low. Thus, each separate audio signal from its corresponding separate speaker, each with their own known sequence of different lengths and amplitude values, such as a maximum length binary sequence with a Gold Code or Kasami sequences, are received at the audio receiver 110 coupled to one or more microphones, and subsequently, undergo audio filtering and processing in the audio receiver 110 so that the audio receiver 110 can tease apart each soundwave with its corresponding known sequence of different lengths and amplitude values waveforms from each other. Each of the corresponding impulse responses (corresponding to coming from its own loudspeaker in the array of speakers) can be compared to at least one of i) a baseline audio reference signal and/or ii) each other. The results from the comparison can be used to determine many things such as whether any of the loudspeakers being tested has a fault, and/or what audio signal experience someone sitting at the microphone location will be experiencing.

The rapid calibration of multi-loudspeaker arrays allows all of the measurements to be carried out simultaneously. The rapid calibration of multi-loudspeaker arrays can use a hissing noise (or any other appropriate tone) for calibration and does not need to use pure tones at relatively high decibel levels, which are annoying to hear. Again, the audio receiver 110 with its audio digital signal processor (DSP) has filters and audio processing circuits to tease apart the individual impulse responses for each speaker. The entire measurement process of the calibration, even for large arrays of speakers, can be carried out quickly. It would be possible to use this in the presence of an audience of people, say immediately before the start of a film or musical performance. Also, the processing gain inherent in the technique would allow the measurement to be made with a relatively low-level signal, so as not to disturb the listeners (e.g., audience of people).

The rapid calibration of multi-loudspeaker arrays inserts the known sequences of different lengths and amplitude values in the hiss sounding soundwaves. The hiss sounding soundwaves each with its own unique known sequence of different lengths and amplitude values is fed by the microphones into the audio receiver 110. The multiple channel waveform generator 105 outputs at least one of i) each uniquely coded waveform itself, ii) the parameters for each uniquely coded waveform, and iii) a combination of both into the loudspeakers on a continuous or periodic basis during use, at very low level and at a corresponding long integration so that calibration can be carried out unobtrusively during a performance (e.g. movie, concert, etc.). The net effect of the rapid calibration of multi-loudspeaker arrays is that measurements are carried out in an unoccupied state and less frequently. Acoustic conditions change with occupancy levels as well as atmospheric conditions (temperature and relative humidity, mostly). Thus, these calibrations can occur at every performance versus once at the initial set up of the speakers and microphones.

As outlined above, a main difference of the rapid calibration of multi- loudspeaker arrays is significantly faster measurement times. A secondary advantage is the use of a not annoying, noise-like, signal during the calibration process. The rapid calibration of multi-loudspeaker arrays provides faster calibration, which can be carried out more frequently resulting in better sound quality. The rapid calibration of multi- loudspeaker arrays can be used with any calibration technique using broadband noise- like signals where multiple speakers are active simultaneously. The rapid calibration of multi-loudspeaker arrays does not have to track what ambient noise is being generated when each individual speaker is being tested because all of the speakers are being tested at approximately the same time; and thus, the ambient noise at the microphone/receiver is about the same at the time when the generated audio signal from the speaker is being received at the microphone. Again, multiple microphones may be used, each with its own known location. For example, a first microphone can be picking up a soundwave/audio from the speakers being tested in a first room, such as a kitchen and a second microphone can be picking up the soundwave/audio from the speakers being tested in a second room, such as a family room. Referring back to FIG. 1, the microphones can pick up the multiple soundwaves/audio signals from the multiple speakers being tested in, for example, an auditorium.

### Additional Example Practical Applications

The rapid calibration of multi-loudspeaker arrays can be integrated with calibration system such as Digital Room Correction for demos and testing. The rapid calibration of multi-loudspeaker arrays can be integrated with loudspeaker arrays. For example, Dolby Cinema Atmos and Meyer Sound Constellation installations in theaters and auditoriums often have over 30 loudspeakers. High-end home theater installations often have 9-12 loudspeakers. Experimental/research installations can have over 100 loudspeakers. Vehicles may have multiple speakers coupled with multiple microphones to provide ambient noise cancellation so that the intended audio from the multiple speakers can be better heard by a person in a specific location within that vehicle, e.g., driver, backseat passenger, etc. Example loudspeaker arrays exist at Stanford CCRMA (e.g., 52 speakers), Satosphere (e.g., 157 speakers), and the Sound Dome at ZKM. An app on a smartphone can test all of the speakers in a home at once, etc. The app can illuminate a green, yellow, or red indication for each speaker letting the user know that for example, speaker number seven in the array of speakers is not working properly. In another approach, the rapid calibration process can supply inputs into speakers and a calibration/determination can be made at a number of receiving devices (e.g., microphones-such as hearing aids, noise cancellation systems, etc.).

Sequentially testing each speaker individually/one at a time in a speaker array could take, for example, 30 seconds per speaker. Sequentially testing each speaker individually/one at a time in a speaker array of, for example, 10 speakers, could take 300 seconds to test all of them. The ambient background noise at the first speaker being tested a time zero could be different than 270 seconds later when the tenth speaker is being tested. The rapid calibration of multi-loudspeaker arrays may test all of the speakers at the same time; and thus, eliminates a change in ambient background noise as something that needs to be factored when comparing the first speaker to the tenth speaker tested.

In addition, the duration to capture all of the data for i) the rapid calibration of all of the speakers in the array at the same time is much shorter than ii) sequentially testing each speaker individually/one at a time. For the example above, 30 seconds is needed to test all of the speakers when tested all at the same time and 300 seconds is needed to test all of the speakers one at a time. Because of the shorter duration, the calibration test will be run at a more often.

### Computing Systems

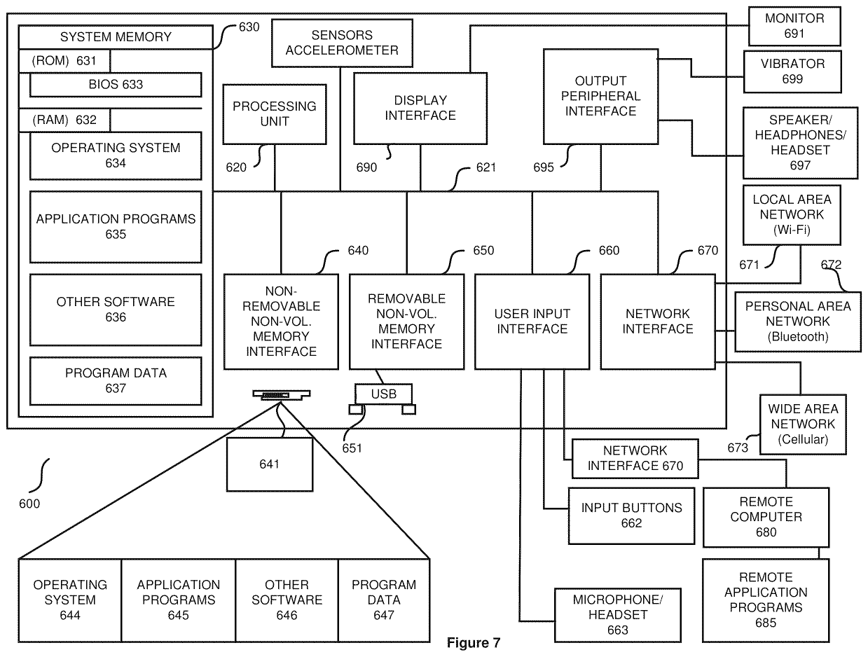

FIG. 7 illustrates a diagram of an embodiment of a computing device that can be a part of the systems associated with the waveform generator 105, the audio receiver 110, and other associated modules discussed herein. The computing device 600 may include one or more processors or processing units 620 to execute instructions, one or more memories 630-632 to store information, one or more data input components 660-663 to receive data input from a user of the computing device 600, one or more modules that include the management module, a network interface communication circuit 670 to establish a communication link to communicate with other computing devices external to the computing device, one or more sensors where an output from the sensors is used for sensing a specific triggering condition and then correspondingly generating one or more preprogrammed actions, a display screen 691 to display at least some of the information stored in the one or more memories 630-632 and other components. Note, portions of this system that are implemented in software 644, 645, 646 may be stored in the one or more memories 630-632 and are executed by the one or more processors 620.

As discussed, portions of the waveform generator 105, the audio receiver 110, and other associated modules can be implemented with aspects of the computing device.

The system memory 630 includes computer storage media in the form of volatile and/or nonvolatile memory such as read-only memory (ROM) 631 and random access memory (RAM) 632. These computing machine-readable media can be any available media that can be accessed by computing system 600. By way of example, and not limitation, computing machine-readable media use includes storage of information, such as computer-readable instructions, data structures, other executable software, or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 600. Transitory media such as wireless channels are not included in the machine-readable media. Communication media typically embody computer readable instructions, data structures, other executable software, or other transport mechanism and includes any information delivery media.

The system further includes a basic input/output system 633 (BIOS) containing the basic routines that help to transfer information between elements within the computing system 600, such as during start-up, is typically stored in ROM 631. RAM 632 typically contains data and/or software that are immediately accessible to and/or presently being operated on by the processing unit 620. By way of example, and not limitation, the RAM 632 can include a portion of the operating system 634, application programs 635, other executable software 636, and program data 637.

The computing system 600 can also include other removable/non-removable volatile/nonvolatile computer storage media. By way of example only, the system has a solid-state memory 641. The solid-state memory 641 is typically connected to the system bus 621 through a non-removable memory interface such as interface 640, and USB drive 651 is typically connected to the system bus 621 by a removable memory interface, such as interface 650.

A user may enter commands and information into the computing system 600 through input devices such as a keyboard, touchscreen, or software or hardware input buttons 662, a microphone 663, a pointing device and/or scrolling input component, such as a mouse, trackball or touch pad. These and other input devices are often connected to the processing unit 620 through a user input interface 660 that is coupled to the system bus 621, but can be connected by other interface and bus structures, such as a parallel port, game port, or a universal serial bus (USB). A display monitor 691 or other type of display screen device is also connected to the system bus 621 via an interface, such as a display interface 690. In addition to the monitor 691, computing devices may also include other peripheral output devices such as speakers 697, a vibrator 699, and other output devices, which may be connected through an output peripheral interface 695.

The computing system 600 can operate in a networked environment using logical connections to one or more remote computers/client devices, such as a remote computing system 680. The remote computing system 680 can a personal computer, a mobile computing device, a server, a router, a network PC, a peer device or other common network node, and typically includes many or all of the elements described above relative to the computing system 600. The logical connections can include a personal area network (PAN) 672 (e.g., Bluetooth®), a local area network (LAN) 671 (e.g., Wi-Fi), and a wide area network (WAN) 673 (e.g., cellular network), but may also include other networks such as a personal area network (e.g., Bluetooth®). Such networking environments are commonplace in offices, enterprise-wide computer networks, intranets and the Internet. A browser application may be resonant on the computing device and stored in the memory.

When used in a LAN networking environment, the computing system 600 is connected to the LAN 671 through a network interface 670, which can be, for example, a Bluetooth® or Wi-Fi adapter. When used in a WAN networking environment (e.g., Internet), the computing system 600 typically includes some means for establishing communications over the WAN 673. With respect to mobile telecommunication technologies, for example, a radio interface, which can be internal or external, can be connected to the system bus 621 via the network interface 670, or other appropriate mechanism. In a networked environment, other software depicted relative to the computing system 600, or portions thereof, may be stored in the remote memory storage device. By way of example, and not limitation, the system has remote application programs 685 as residing on remote computing device 680. It will be appreciated that the network connections shown are examples and other means of establishing a communications link between the computing devices that may be used.

In some embodiments, software used to facilitate algorithms discussed herein can be embedded onto a non-transitory machine-readable medium. A machine-readable medium includes any mechanism that stores information in a form readable by a machine (e.g., a computer). For example, a non-transitory machine-readable medium can include read-only memory (ROM); random access memory (RAM); magnetic disk storage media; optical storage media; flash memory devices; Digital Versatile Disc (DVD's), EPROMs, EEPROMs, FLASH memory, magnetic or optical cards, or any type of media suitable for storing electronic instructions.

Note, an application described herein includes but is not limited to software applications, mobile applications, and programs that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C+, HTTP, Java, Python, or other similar languages. Also, an algorithm can be implemented with lines of code in software, configured logic gates in software, or a combination of both. Any portions of an algorithm implemented in software can be stored in an executable format in portion of a memory and is executed by one or more processors. In an embodiment, a module can be implemented with electronic circuits, software being stored in a memory and executed by one or more processors, and any combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

References in the specification to “an embodiment,” “an example”, etc., indicate that the embodiment or example described may include a particular feature, structure, or characteristic, but every embodiment may not necessarily include the particular feature, structure, or characteristic. Such phrases can be not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

1. An apparatus, comprising:
a waveform generator configured to generate two or more sequences of uniquely coded waveforms, where the waveform generator is configured to output at least one of i) each uniquely coded waveform itself, ii) parameters for each uniquely coded waveform, and iii) a combination of both, where the uniquely coded waveforms each have a known sequence of at least one of 1) different lengths, 2) different amplitude values, and a 3) combination of both, forming a unique identifier for that known sequence as inputs into multiple loudspeakers in an array being tested, where the multiple loudspeakers are configured to generate audio signals, where each audio signal has its own uniquely coded waveform with the known sequence, at approximately a same time and to be received by one or more microphones to perform a simultaneous characterization of at least one of i) a calibration of, and ii) a performance of the multiple loudspeakers in the array.

2. The apparatus of claim 1, where the known sequence of different lengths and amplitude values are a set of Gold code sequences that are generated with respect to each other such that low-cross-correlation occurs between audio signals coming from different loudspeakers being tested.

3. The apparatus of claim 1, where the known sequence of different lengths and amplitude values are a set of Kasami sequences that are generated with respect to each other such that low-cross-correlation occurs between audio signals coming from different loudspeakers being tested.

4. The apparatus of claim 1, where the uniquely coded waveforms are configured, when the multiple loudspeakers generate the audio signals, to sound like noise.

5. The apparatus of claim 1, where each microphone is configured to feed received audio signals transmitted from each of the multiple loudspeakers into an audio receiver as well as to attach a unique identifier associated with that microphone into the received audio signals so that the audio receiver can process all of the audio signals transmitted by the multiple loudspeakers at a same time as well as factor in a geographically known location of each microphone relative to each of the multiple loudspeakers.

6. The apparatus of claim 1, where the waveform generator is a binary sequence generator configured to supply the sequence of uniquely coded noise waveforms which include at least the known sequence of different lengths and amplitude values to an audio receiver so that convolution filters in the audio receiver can match up a particular audio signal with the uniquely coded noise waveform generated by an individual loudspeaker in the array to the known sequence of different lengths and amplitude values sent to that particular loudspeaker.

7. The apparatus of claim 1, further comprising:
an audio receiver coupled to the one or more microphones that has a set of convolution filters equal to or greater than an amount of multiple loudspeakers being tested at the same time in the audio receiver so that the set of convolution filters can correlate the audio signal generated by an individual loudspeaker in the array to the uniquely coded waveform sent to that particular loudspeaker.

8. The apparatus of claim 1, where the one or more microphones are positioned at geographically known locations relative to each of the multiple loudspeakers to receive the generated audio signal from each loudspeaker in the multiple loudspeaker array being tested at the same time.

9. The apparatus of claim 1, further comprising:
an audio receiver coupled to the microphones is configured to correlate received audio signals from each loudspeaker, where each received audio signal contains its own unique waveforms which have the known sequence of different lengths and amplitude values correlatable to a corresponding loudspeaker in the multiple loudspeaker array.

10. The apparatus of claim 1, further comprising:
an audio receiver configured to have an audio digital signal processor that has filters and audio processing circuits configured to electronically tease received audio signals in the audio signals apart and produce individual impulse responses corresponding to each loudspeaker in the multiple loudspeaker array being tested at the same time.

11. A method for testing multiple speakers in an array of the multiple loudspeakers, comprising:
generating two or more sequences of uniquely coded waveforms with a waveform generator,
outputting from the waveform generator at least one of i) each uniquely coded waveform itself, ii) parameters for each uniquely coded waveform, and iii) a combination of both, where the uniquely coded waveforms each have a known sequence of at least one of 1) different lengths, 2) different amplitude values, and a 3) combination of both, forming a unique identifier for that known sequence as inputs into the multiple loudspeakers in the array being tested, and
generating audio signals from the multiple loudspeakers at approximately a same time to be received by one or more microphones to perform a simultaneous characterization of at least one of i) a calibration of, and ii) a performance of the multiple loudspeakers in the array, where each audio signal has its own uniquely coded waveform with the known sequence.

12. The method of claim 11, where the known sequence of different lengths and amplitude values are a set of Gold code sequences that are generated with respect to each other such that low-cross-correlation occurs between audio signals coming from different loudspeakers being tested.

13. The method of claim 11, where the known sequence of different lengths and amplitude values are a set of Kasami sequences that are generated with respect to each other such that low-cross-correlation occurs between audio signals coming from different loudspeakers being tested.

14. The method of claim 11, where the uniquely coded waveforms are configured, when the multiple loudspeakers generate the audio signals, to sound like noise.

15. The method of claim 11, where each microphone is configured to feed received audio signals transmitted from each of the multiple loudspeakers into an audio receiver as well as to attach a unique identifier associated with that microphone into the received audio signals so that the audio receiver can process all of the audio signals transmitted by the multiple loudspeakers at a same time as well as factor in a geographically known location of each microphone relative to each of the multiple loudspeakers.

16. The method of claim 11, where the waveform generator is a binary sequence generator configured to supply the sequence of uniquely coded noise waveforms which include at least the known sequence of different lengths and amplitude values to an audio receiver so that convolution filters in the audio receiver can match up a particular audio signal with the uniquely coded noise waveform generated by an individual loudspeaker in the array to the known sequence of different lengths and amplitude values sent to that particular loudspeaker.

17. The method of claim 11, further comprising:
using an audio receiver to receive the audio signals from the one or more microphones, where the audio receiver has a set of convolution filters equal to or greater than an amount of multiple loudspeakers being tested at the same time in the audio receiver so that the set of convolution filters can correlate the audio signal generated by an individual loudspeaker in the array to the uniquely coded waveform sent to that particular loudspeaker.

18. The method of claim 11, where the one or more microphones are positioned at geographically known locations relative to each of the multiple loudspeakers to receive the generated audio signal from each loudspeaker in the multiple loudspeaker array being tested at the same time.

19. The method of claim 11, further comprising:
using an audio receiver to receive the audio signals from the one or more microphones, where the audio receiver is configured to correlate received audio signals from each loudspeaker, where each received audio signal contains its own unique waveforms which have the known sequence of different lengths and amplitude values correlatable to a corresponding loudspeaker in the multiple loudspeaker array.

20. The method of claim 11, further comprising:
using an audio receiver to receive the audio signals from the one or more microphones, where the audio receiver is configured to have an audio digital signal processor that has filters and audio processing circuits configured to electronically tease received audio signals in the audio signals apart and produce individual impulse responses corresponding to each loudspeaker in the multiple loudspeaker array being tested at the same time.
